(19) United States
(12) Patent Application Publication
(10) Pub. No.: US 2002/0026768 A1
(43) Pub. Date: Mar. 7, 2002

(54) Order builder

(76) Inventors: Gregory Scott Duncan, Jacksonville, FL (US); John M. Lepper, Jacksonville, FL (US); Stephen R. Beaton, Jacksonville, FL (US); Donnie J. Duis, Jacksonville, FL (US)

Correspondence Address: AUDLEY A. CIAMPORCERO JR., JOHNSON & JOHNSON, ONE JOHNSON & JOHNSON PLAZA, NEW BRUNSWICK, NJ, 08933-7003, US

(21) Appl. No.: 09/903,249

(22) Filed: Jul. 11, 2001

Related U.S. Application Data
(63) Continuation-in-part of application No. 09/494,859, filed on Feb. 1, 2000.

(51) Int. Cl. B07C 5/02

(52) U.S. Cl. 53/52; 209/583; 209/539; 209/933

(57) ABSTRACT

The invention pertains to a process and apparatus for automatically sorting and sequencing a random assemblage of products associated with a particular order for same. In one embodiment, the invention sequences the random products to match a predetermined label application sequence.

This application is a continuation-in-part of U.S. Ser. No. 09/494,859, filed Feb. 1, 2000, entitled “CUSTOMIZED PRESCRIPTION PRODUCT PACKAGING AND METHOD AND SYSTEM FOR PRODUCING CUSTOMIZED PRESCRIPTION PRODUCT PACKAGING” (VTN-0458), the contents of which are hereby incorporated, in their entirety, by reference.

### BACKGROUND OF THE INVENTION

1. Field of the Invention

The invention relates to a method and system for the automatic sorting of products into individual orders where said products are provided in a random assemblage in fulfillment of orders for same. In a specific practice of the invention, the products, e.g. packaged ophthalmic lenses, are automatically sorted and sequenced to match the exact sequence by which labels associated with a particular order will be applied to the individual products making up the order. In one embodiment, the labels associated with one or more of the particular orders have custom graphics thereon thus compelling correct match up of label and product.

2. Description of the Prior Art

The processing of orders and related product handling in fulfillment of same has become evermore complex. Hitherto, orders were manually filled by human operators who handpicked needed products from inventory, packed, labeled and shipped them; but the increasing diversity of product and customers have made this economically impractical. One of the difficulties in automating the building of orders is in the handling of mixed orders and/or orders of small size: in the ordinary course, a large order for the same product to the same customer can be more expeditiously processed because the picking of product and labeling of same necessarily entails fewer steps with commensurately fewer opportunities for error.

One way to accommodate the building of smaller orders and/or mixed orders is to pick the needed products from inventory and label them for a given order until that order is completely filled; the process of picking and labeling then commences for the next order until that order is filled and so on. This seriatim technique, however, proves to be inefficient in large scale or quick-turn-around settings where, among other things, the sequence of picking product from inventory is often governed by other considerations; for example, products having greater historical usage may be more conveniently located in inventory and picked first, to concurrently satisfy several orders that call for same, before a less popular product needed to fill a given order is pulled. In such circumstances, the products picked are delivered in a random sequence to a downstream location whereat they are manually sorted, with the individual orders built accordingly by human operators.

Automating the building of orders from a randomly sequenced assemblage of products pulled from inventory to fill a multiplicity of orders is further complicated by the growing demand of customers for customization of products and/or packaging. Customization effectively multiplies the complexity of the process by creating additional distinctions in the products being sorted, which distinctions have to be tracked and accounted for in building a given order.

There is thus an on-going need for the development of a process and a system for the automatic sorting and sequencing of a random assemblage of products to build orders.

### SUMMARY OF THE INVENTION

In advancing the foregoing state-of-affairs, the present invention provides a process and system for automatically sorting a random assemblage of products into individual orders. In a particular practice, the instant invention sorts and sequences such products to exactly match the sequence by which labels uniquely customized for a particular order will be placed on the individual products associated with that order.

In one embodiment, the automatic process of the invention comprises:

a) providing at least one computer having access to one or more databases in which is stored i) order information for a multiplicity of orders for the same or different products and ii) product identifier information;

b) providing a random assemblage of products in response to said order information, each of said products having a product identifier thereon;

c) scanning the product identifiers on the products of said random assemblage to cause sorting by transferring individual products associated with a particular order to an order builder zone for that order.

In another embodiment, the automatic process of the invention comprises:

a) receiving a multiplicity of orders for the same or different products and storing same in one or more databases in which is also stored label information, including a label sequence by which labels will be applied to the individual products associated with each order, and in which is also stored product identifier information;

b) providing at least one computer having access to said one or more databases;

c) providing products in fulfillment of said multiplicity of orders to a scanner in a random sequence, each of said products having thereon a product identifier;

d) scanning the product identifier on each product and determining from said one or more databases which of the multiplicity of orders each product belongs to and where each product belongs in the label sequence;

e) grouping together the individual products associated with each order and sequencing them to match the label sequence.

In yet another embodiment, the invention pertains to a system for automatically sorting a random assemblage of products into individual orders, each of said products having a product identifier thereon, the system comprising:

(a) one or more databases in which is stored i) order information for a multiplicity of orders for the same or different products and ii) product identifier information;

(b) at least one computer having access to said one or more databases;

(c) scanning means to read the product identifiers on said random assemblage of products and input same into said one or more databases;

(d) sorting means controlled by said computer to transfer products associated with a particular order to an order builder zone for that order.

### BRIEF DESCRIPTION OF THE DRAWINGS

Reference may now be had to the following detailed description of the preferred embodiments of the invention, taken in conjunction with the accompanying drawings; in which:

FIG. 1 illustrates a perspective top and side view of a blister pack array with customized graphics;

FIG. 2 illustrates a perspective top and side view of a carton with customized graphics;

FIG. 3 illustrates a top view of an insert with customized graphics;

FIG. 4 illustrates a top view of a label having customized graphics for a carton; and

FIG. 5 is a schematic of a top view of a system for printing out labels having customized graphics for adhering to a carton.

FIG. 6 is an embodiment of a database useful for tracking labels and various information in the sorting and sequencing of the present invention in the printing system shown in FIG. 5.

FIG. 7 illustrates a top plan view of an embodiment of the order builder system contemplated by the invention.

FIGS. 8A to 8F illustrate a cycle of an embodiment for the automatic sequencing of product packages contemplated by the invention.

### DETAILED DESCRIPTION OF THE PREFERRED EMBODIMENTS

The invention will be described in the context of its preferred embodiment where the product is a prescription product. Prescription products in this regard include without limitation ophthalmic lenses, medications, spectacles, medical devices, or the like. The preferred prescription product is an ophthalmic lens which includes, without restriction, hard contact lenses, soft contact lenses, rigid gas permeable contact lenses or intraocular lenses and lenses for eyeglasses. Contact lenses, especially soft contact lenses, are most preferred as the prescription product.

The term “identification means” or “identifier” is a number, bar-code, twodimensional matrix, three dimensional matrix, inductive transmitting/receiving device, or radio frequency chip, or the like. Preferably each identification means/identifier contains some unique information for every part having one. The identification means/identifier may be machine readable and/or human readable, preferably at least machine readable. A machine readable identification means/identifier preferably has information stored in a database associated with the identification means. For packaging, the information stored in the database associated with the identification means/identifier may not be present on the packaging in human-readable form. That is, the only way to know which product is in the packaging is to access the information in the database by inputting the identification means into the database, via a bar-code reader or the like.

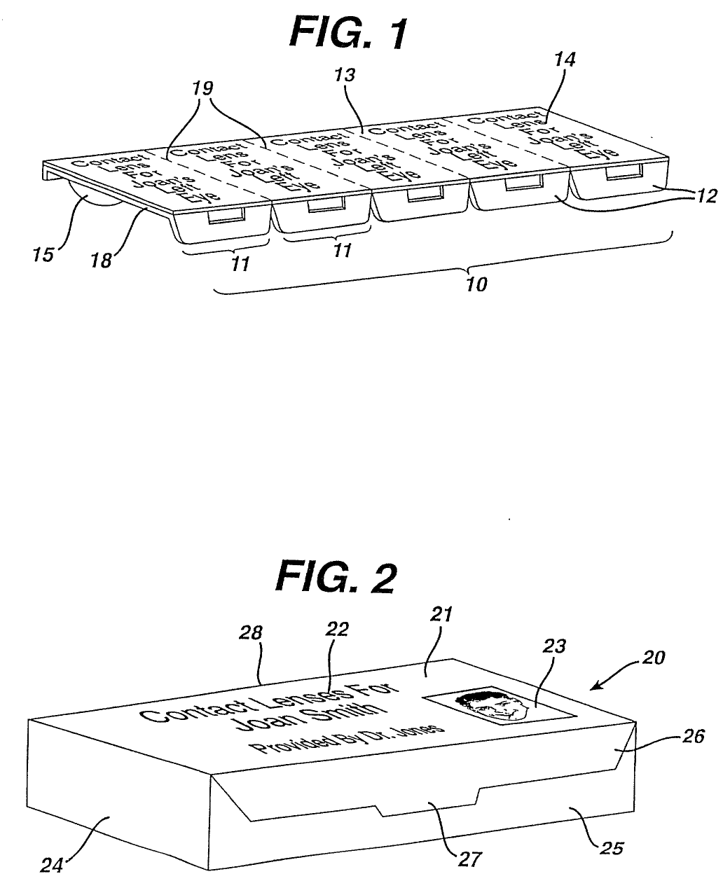

As shown in FIGS. 1, 2, and 3 the packaging having customized graphics which houses at least one contact lens can be part of any of the packaging for the contact lens. Typically, contact lens packaging comprises primary packaging and secondary packaging. The primary packaging is the packaging adjacent to the contact lens, the secondary packaging surrounds the primary packaging. There can be any number of layers of packaging for the contact lens; however, in the preferred embodiment, there is primary packaging and secondary packaging. Customized graphics can be added to the primary, and/or secondary packaging and/or it can be a package insert, typically placed within the secondary packaging. The customized graphics can be an alphanumeric message, picture, photograph, and/or the like, or combinations of the above.

The primary packaging for a contact lens is preferably a blister pack with a lidstock, but it can take any form, e.g. a glass bottle, cans, trays, pouches, e.g. form-fill-and-seal pouches, as long as it provides adequate protection for the contact lens. FIG. 1 shows a blister pack array 10 having customized graphics. The blister pack array 10 consists of five blister packs 11. Each blister pack 11 consists of an individual base 12 all five of which are interconnected by a contiguous lidstock 13, which is scored so that the individual blister packs 11 can be detached from the array 10. Each base 12 preferably comprises injection-molded or thermoformed plastic incorporating a molded cavity 15 which is surrounded by an outstanding planar flange 18 about the rim of the cavity 15. A flexible cover sheet or lidstock 13 is adhered to the surface of the flange 18 so as to sealingly enclose the cavity 15 in a generally air and liquid-tight mode. Within the cavity 15 of the base portion, a contact lens (not shown) is inunersed in a sterile aqueous solution (not shown). Preferably the contact lens is a hydrophilic contact lens manufactured of materials known to those of ordinary skill in the art. The customized graphics 14 shown are present on the lidstock 13 and indicate the patient to receive the contact lens in each blister pack, and which eye of the patient the contact lens should be placed in. The customized graphics 14 state on the lidstock for each blister pack: “CONTACT LENS FOR JOAN'S LEFT EYE”. There may be no prescription information e.g. power for spherical contact lenses or power, cylinder, axis for toric contact lenses present on the packaging, only information indicating who the product is for, and directions for its proper use. The packaging may only be identified and tracked by the manufacturer by at least one identification means, also referred to as a product identification means, preferably a machine readable identification means present on the packaging, preferably on at least the secondary packaging, more preferably present on both the primary packaging and secondary packaging for contact lenses. The information associated with the product identification means, such as, SKU, lot number, expiration date, can be stored in one or more databases. The information is accessible when the product identification means is inputted into a computer, which can access the database.

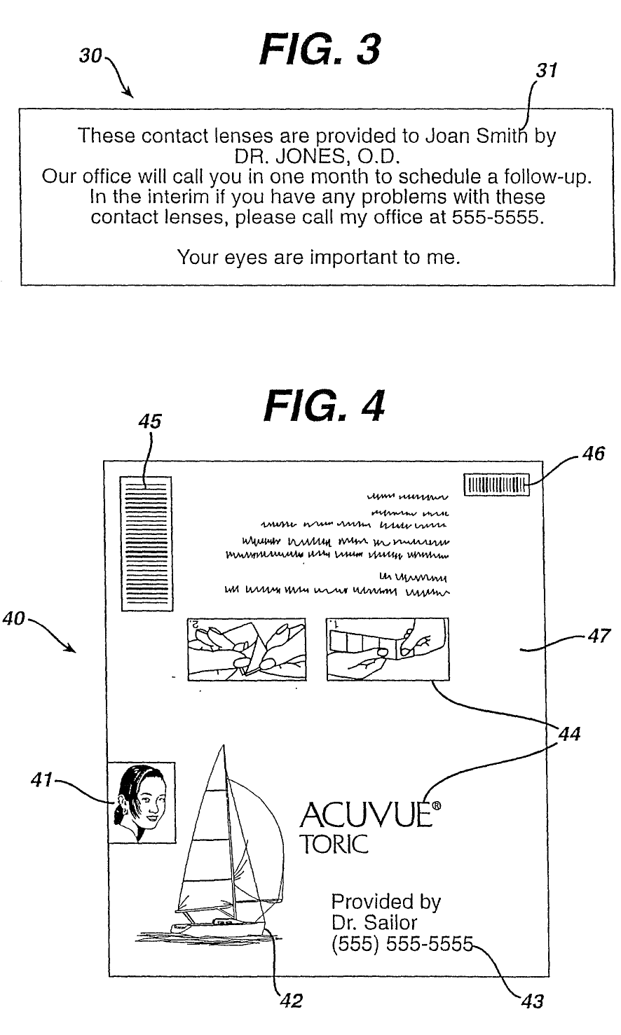

Presently, it is preferred that the packaging for the contact lenses comprise primary and secondary packaging. The preferred secondary packaging is a carton, but it can take any form, such as, bags, plastic wraps, envelopes, pouches, cans, boxes, bottles, or trays. The secondary packaging preferably houses multiple primary packages. The preferred secondary packaging is shown in FIG. 2. FIG. 2 shows a carton 20, which preferably houses multiple contact lenses each in primary packaging (such as one more of the arrays shown in FIG. 1). The rectangular carton 20 preferably comprises paperboard. The carton 20 includes flat top wall panel 21 and opposing bottom wall panel (not shown) respective front panel 25 and opposing rear panel (not shown), and opposite end walls 24 (only one shown) which are sealed through an adhesive or glued construction as is known in the carton forming technology. The top wall panel 21 includes a downwardly depending front flap 26 having a centrally located latching tab 27 at a lower edge thereof which is adapted to be tucked into a cooperating latching slit (not shown) centrally formed in the front panel 25 to facilitate reclosing of the carton 20. The top wall panel 21 is adapted to be swung upwardly about a rear hinge line 28 to open the carton 20. The top wall panel 21 of the carton is shown having the customized graphics 22, 23 which consist of alphanumerics 22 and a picture 23. The alphanumerics 22 state: “CONTACT LENSES FOR JOAN SMITH PROVIDED BY DR. JONES”. The picture 23 is a photograph of the doctor, Dr. Jones, who prescribed the contact lenses.

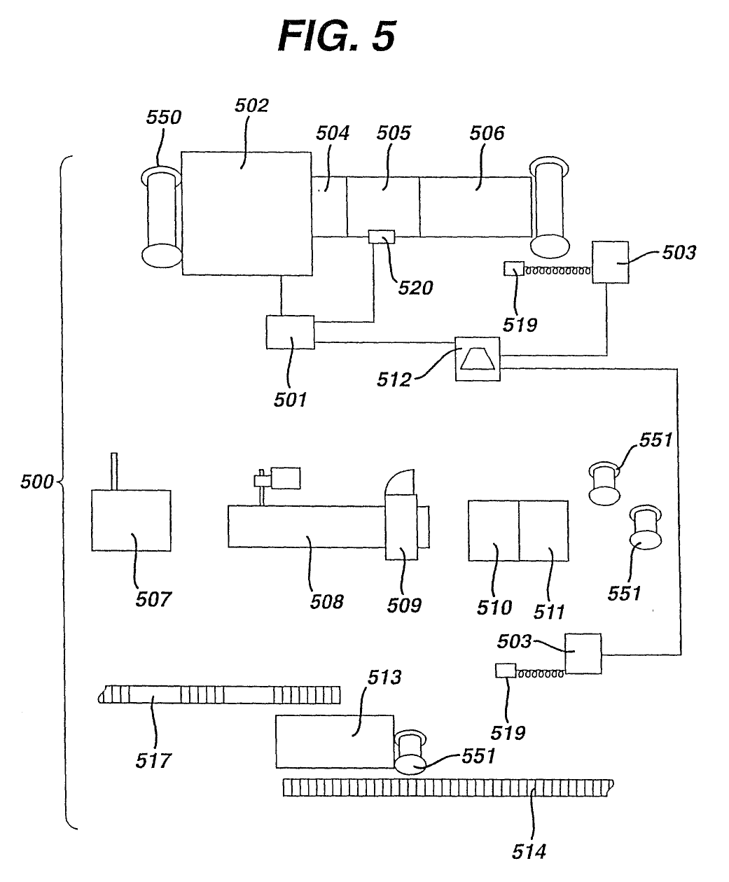

FIG. 3 shows an embodiment in which the customized graphics are added to a package insert. The package insert can be a paper or any object, e.g. a toy, a mirror, etc., which is added to the packaging. FIG. 3 shows the insert 30 as a piece of paper, and the customized graphics 31 is an alphanumeric message which states: “These contact lenses are provided to Joan Smith by DR. JONES, O. D. Our office will call you in one month to schedule a follow-up. In the interim if you have any problems with these contact lenses, please call my office at 555-5555. Your eyes are important to me.” The package insert paper 30 can be folded up to fit into the secondary packaging, e.g. carton. The customized graphics shown in the figures are exemplary. Any alphanumeric message, picture, or photograph selected by the doctor, or patient could be used.

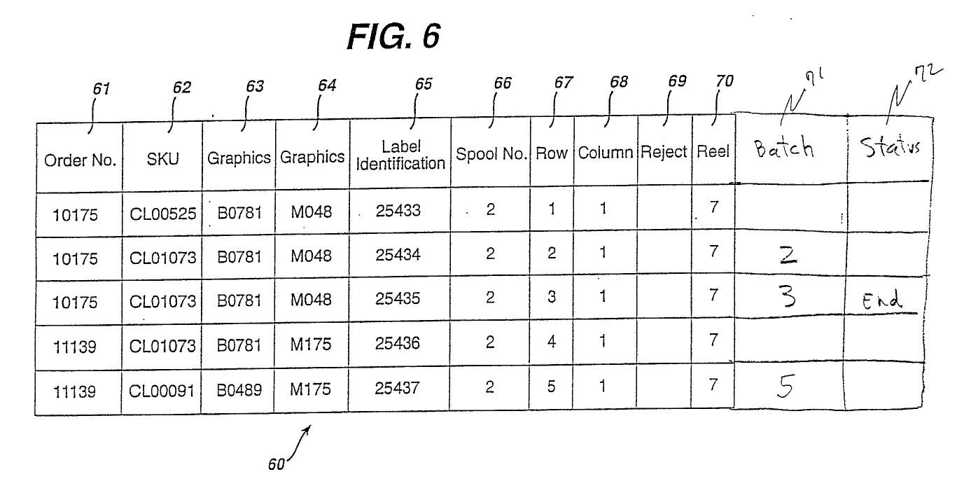

FIG. 4 shows a label 40. The label may be adhered to blank areas of the packaging or it may be an over-label, meaning it may be adhered to areas of the packaging which are partially or fully labeled for distribution. The label 40 is preferably an adhesive sticker. The label 40 as shown is shaped for use on a carton similar to the carton shown in FIG. 2. The label 40 consists of a top layer 47 comprising paper, polymer, (e.g. polyvinylchloride film) or metal film, preferably paper. Preferably there is an adhesive layer (not shown) coated on the back side of the top layer 47. The label 40 may be attached to a peel layer (not shown) which the top layer 47 and the adhesive layer can be peeled from before attaching the label 40 to the package. Preferably, the adhesive is a permanent adhesive, e.g. Avery Dennison adhesive LP-430 Permanent/Emulsion Acrylic with service temperature range −54 to +93° C.; Avery Dennison adhesive S-4600 Permanent/Acrylic with service temperature range −40 to +80° C. Alternatively, the label 40 may only consist of a top layer 47 and the adhesive can be applied to the packaging before the top layer is applied to the packaging. The label 40 has multiple types of customized graphics 41, 42, and 43. The label 40 has a doctor's photograph 41, a picture of a sail boat 42, and an alphanumeric message 43 indicating that the contact lenses are “Provided by Dr. Sailor (555) 555-5555”. The photograph, picture and alphanumeric message are all selected by the doctor. The doctor could specify (or a patient may select) a picture which he/she knows is well suited for a patient, e.g. a horse for a horse-lover.

As shown in FIG. 4, the label may comprise additional information such as a product identification means 45, and a label identification means 46, preferably both identification means are machine-readable identification means. The product identification means 45 is used to identify the type of the contact lenses and the prescription of the contact lenses that are within the carton to which the label 40 is to be adhered to. The optional label identification means 46 can be used to identify the specific label 40, so that it can be tracked on and off the carton, so that the label is put on the correct carton, and so the product is sent to the proper recipient, either the patient or the doctor. Also, in the preferred embodiment, the label identification means is used through the customized graphics printing system for tracking the quality of the label. Alternatively, the label identification means 46 may be in a portion of the top layer 47 of the label which stays with the peel layer when the top layer 47 is removed from the peel layer, preferably just before adhering the label to the correct carton.

Also alternatively, the product identification means 45 may not be on the label and is present instead on an area of the packaging which is not covered when the label 40 is put on the packaging. If the label identification means is not present on the label the order information can be associated with the product identification means in the database and the product identification means can be used to track the packaging after the label is adhered to the packaging. Alternatively, the label identification means can be product identification means if the label identification means is the only identification means present on the packaging.

The label 40 is shown having some standard graphics 44 which are not customized for either the doctor and/or the patient and may be present on the label 40 before (or added to the label 40 after) the customized graphics are printed onto the label 40, or the non-customized graphics can be printed onto the label 40 at the same time that the customized graphics are added. In short, the customized and non-customized graphics can be added to the packaging in any sequence. Non-customized information includes, e.g., identifying legends and logos pertaining to the company manufacturing and/or marketing the product, instructions pertaining to the use of the product packaged in the carton, decorative indicia the contents, directions for use, warnings about dispensing the prescription product without a prescription, and the like.

If the customized graphics are added to the primary package and the primary package comprises a blister pack comprising a bowl and lidstock, it is presently preferred that the customized graphics are added to the lidstock. Either the lidstock can be printed on directly to add the customized graphics or the customized graphics can be added indirectly to the lidstock by printing out a label having customized graphics and adhering the label to the lidstock. Alternatively, a label having a blank area can be adhered to the lidstock and printed on after adhering to the lidstock. The preferred methods for printing out customized graphics on labels will be described in more detail below. (The preferred method described below is presently used to print out labels for cartons, but it can be modified to print out labels for lidstock, instead.) In the embodiment shown in FIG. 1, the customized graphics 10 were added to the lidstock 13 directly by printing onto the lidstock. Either an area on the lidstock can be reserved for the customized graphics or the customized graphics can cover the entire lidstock.

It is presently preferred that the customized graphics are added to the secondary packaging. Presently the preferred secondary packaging is a carton. The customized graphics can be added to either the outside or inside surface area of the secondary packaging. The customized graphics are preferably present on at least 5 percent of the outside surface area of the secondary packaging, more preferably at least up to 25 percent, and most preferably at least 50 percent of the outside surface area of the secondary packaging. Preferably the customized graphics comprise a background image which is present on at least 30 percent, more preferably at least 60 percent and most preferably at least 80 percent of the surface area of the secondary packaging. For a carton, preferably, at least one panel or wall has some customized graphics, more preferably at least two panels have some customized graphics, most preferably at least three panels have some customized graphics. Alternatively or in addition to the customized graphics on the outside surface of the secondary packaging, the customized graphics can cover a portion of the inside surface area of the secondary packaging. Presently, it is preferred that the outside surfaces of the secondary packaging carry the customized graphics.

The customized graphics can be added to the secondary packaging either directly or indirectly. The secondary packaging can be printed on directly or a label may be adhered to the secondary packaging and then printed upon. For indirect printing, the customized graphics can first be printed onto a label such as the one shown in FIG. 4, such as an adhesive label, which can then be adhered to the secondary packaging. The label can be small or large. The label can be used as part of the means to seal the secondary packaging, or the label can cover a portion of the outside surface area of the secondary packaging which is not near any of the sealing means, that is flaps, tear strips, insert pieces, seams, etc. of the secondary packaging. Although printing on labels first has the drawback that it requires a second step of adhering the labels to the packaging, this method is presently preferred, because not all the contact lenses ordered will be produced for doctors or patients who will want to have the customized graphics added to the packaging. The preferred method of printing out labels will be described in more detail below.

Alternatively, the customized graphics can be printed directly onto the secondary packaging. The secondary packaging may be assembled or disassembled at the time of printing with or without the primary packages within. For example, if the secondary packaging is a carton, the customized graphics may be printed on the carton as a flat carton blank or as an assembled carton which is empty. A support for an assembled empty carton which can be used during printing on the carton is disclosed in Duis et al, “METHOD AND SUPPORT FOR CARTON”, U.S. Ser. No. 09/217,879, filed Dec. 21, 1998 (VTN-442) incorporated herein by reference. Alternatively, the carton may be printed on directly after the contact lens primary packages are inserted into the carton, by laser or ink jet printing. Alternatively, a label having a blank area may be added to the carton and then the customized graphics may be added to the label. If the secondary packaging is not a carton the preferred printing techniques for printing on the secondary packaging can be adapted to the secondary packaging materials used.

Alternatively, the customized graphics can be printed onto an insert which can be inserted into the secondary packaging for example in a manufacturing line before the secondary packaging is sealed.

Printing on the packaging, e.g. primary packaging, secondary packaging, and/or package insert can be by any printing method e.g. by thermal, laser, electrophotographic, ink jet, and pad printing. Some methods are better suited for certain types of packaging materials, which are known to a person of ordinary skill in the art. The preferred method for printing on a label will be described below.

For each embodiment, the method of printing the customized graphics begins with an order from a doctor for prescription contact lenses. The orders are received according to methods known in the prior art, e.g. mail, telephone, internet, fax, except that the order methods are modified so that the doctors/patients have the ability to indicate what customized graphics they would like to have on the packaging and optionally where on the packaging the customized graphics are to be placed. Preferably, there will be a large collection of pictures, photographs, and messages to select from, and each item in the collection will be coded and stored in computer memory, which will be accessible to the printing apparatus. In addition, preferably, the doctors can specify pictures, photographs or messages outside of the collection. For example, when Dr. Jones calls in his order, he can specify which cartons, if any, to print the photograph of himself which he previously provided to the manufacturer, and is stored in the computer memory which is accessible to the printing apparatus. Depending upon what packaging is to receive the customized graphics, that is, primary packaging, secondary packaging, or inserts and if the customized graphics will be added to the packaging in-line or off-line will determine how the order information will be processed. If the customized graphics are to be added to the primary packaging, then the order information will preferably be sent to a manufacturing line which has a printer for the lidstock or labels for the lidstock so that the customized graphics can be added to the primary packaging prior to placing the primary packaging in secondary packaging. If the customized graphics are to be added to the secondary packaging, the information can be sent to a contact lens manufacturing line which will either print directly onto the secondary packaging or will print onto a label for the secondary packaging either prior to or after putting the primary packages of contact lenses into the secondary packaging. The packaging which has been modified preferably will be marked with an identification means, preferably a machine readable identification means identifying to whom the order should be sent so that it can be tracked and sent to the correct doctor or patient. Alternatively, often packaging has a unique machine-readable code (e.g. product identification means) present on its exterior which is used to identify the product and other information, such as, lot number, stock keeping unit (SKU), and expiration date. This machine-readable code can have additional information assigned to it (which is preferably stored in a database) identifying that the package has received customized graphics and to whom the product should be routed. Alternatively or additionally, the exterior of the packaging can be marked with a human-visible indicator signifying that the package has received customized graphics which may be tracked by an operator or will assist a quality check by an operator before shipping an order.

Presently, the preferred method is to manufacture the contact lenses, place the contact lenses in primary packaging, place multiple primary packages of contact lenses in secondary packaging and sterilize the lenses by the customary methods described in the prior art, and then to add the customized graphics to the secondary packaging using a label printed off-line, and preferably added off-line. Preferably, the order information for the customized graphics is sent to a customized graphics printing system which is separate from the contact lens manufacturing line. The customized graphics printing system will print out labels which will cover at least a portion of the outside surfaces of the secondary packagings, e.g. cartons. Preferably, the doctor's orders will be picked from stock in the customary method of assembling the ordered contact lenses in their customary secondary packaging. The labels produced on the customized graphics printing system will then be matched up with the secondary packaging for each doctor's order and then the labels will be adhered to the secondary packaging either in an automated method or manually. After the labels are adhered to the secondary packaging in accordance with the doctor's order, the order will be shipped directly to the doctor or patient.

In an alternative method, the customized graphics can be added in-line, that is, in the manufacturing line in which the contact lenses are produced, and placed in the primary packaging and preferably also placed in the secondary packaging. In the in-line mode, the order information will be provided to the manufacturing line which is producing the ordered contact lenses and the customized graphics will be generated right in the manufacturing line, and added to the packaging in-line. If the customized graphics are to be added to the primary package, at about the time the ordered contact lenses are placed in each of its primary packaging the customized graphics will be added to, for example, the lidstock, and then the lidstock will be heat-sealed to the bowl. If the customized graphics are to be added to the secondary packaging, the carton preferably will be printed on in the manufacturing line prior to placing the primary packagings into the carton and prior to sealing the carton. The printing can be accomplished by any of the methods listed above. The exterior of the packaging, for example the secondary packaging, will preferably have an identification means, preferably a machine-readable code, to which the information in connection with the customized graphics will be stored for delivery to the correct recipient of the contact lenses.

In the preferred method, the graphics will be added off-line, and there will be one or more computerized databases which will track the doctors names and the selected customized graphics. As the orders for prescription products come in, as described above, and assembled in a database the order information will be searched for a request for customized graphics or for a doctor's name who has requested customized graphics on all of his/her packaging. (Alternatively, the order information will be searched for the patient's name that has requested the customized graphics). When one or more orders are found which have requested customized graphics, the customized graphics information will be sent to a customized graphics printing system. In the preferred mode labels having customized graphics will be printed by the customized graphics printing system. Afterwards, the labels will be matched up with the correct packaging, preferably cartons containing the ordered contact lenses. The preferred method of assembling or picking the ordered products is according to the method and by using the apparatus and method disclosed in Duncan et al, “Apparatus and Method for Automated Warehousing and Filling Orders for Multi-Item Inventories”, U.S. Ser. No. ________, filed concurrently herewith, (VTN-453), incorporated herein by reference. The picked (assembled) order will be deferred to the off-line customized graphics printing system for the application of printed labels having the customized graphics to the cartons to receive the labels in accordance with the orders.

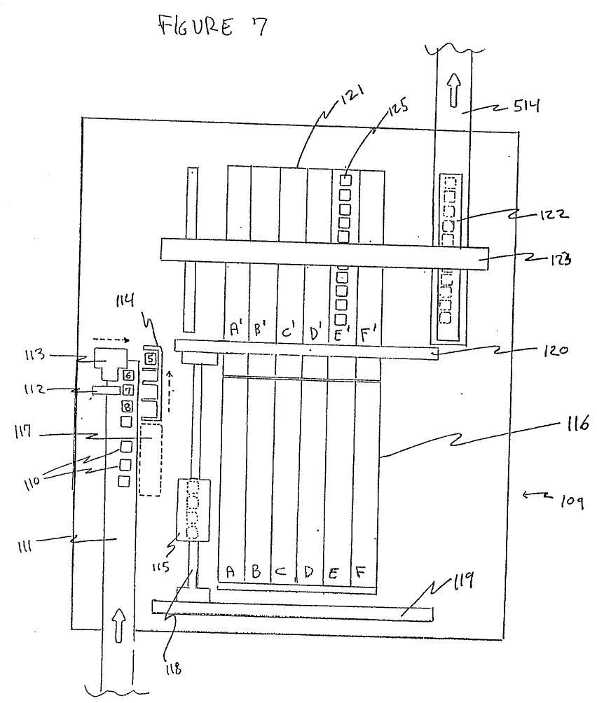

The preferred off-line method for producing labels having customized graphics comprises a printing step, and one or more quality-checking steps. More preferably the method additionally comprises a varnishing step. Most preferably the method additionally comprises one or more cutting steps. These and other steps will be described in relationship to the preferred system for printing out labels having customized graphics as shown in FIG. 5.

FIG. 5 shows the presently preferred customized graphics printing system 500 comprising a printer 502, a quality check station 505, a varnish application apparatus 508, a cutting apparatus 509, a label applicator 513, and preferably shop floor controller 512. The shop floor controller 512 is a computer, or the like, tracks the labels within the printing system 500. The shop floor controller comprises memory, programs, processor, databases, and the ability to receive information, e.g., from parts of the printing system 500, and output information, and instructions, e.g., which effect the function of parts of the printing system. The operation of the shop floor controller 512 will be described below.

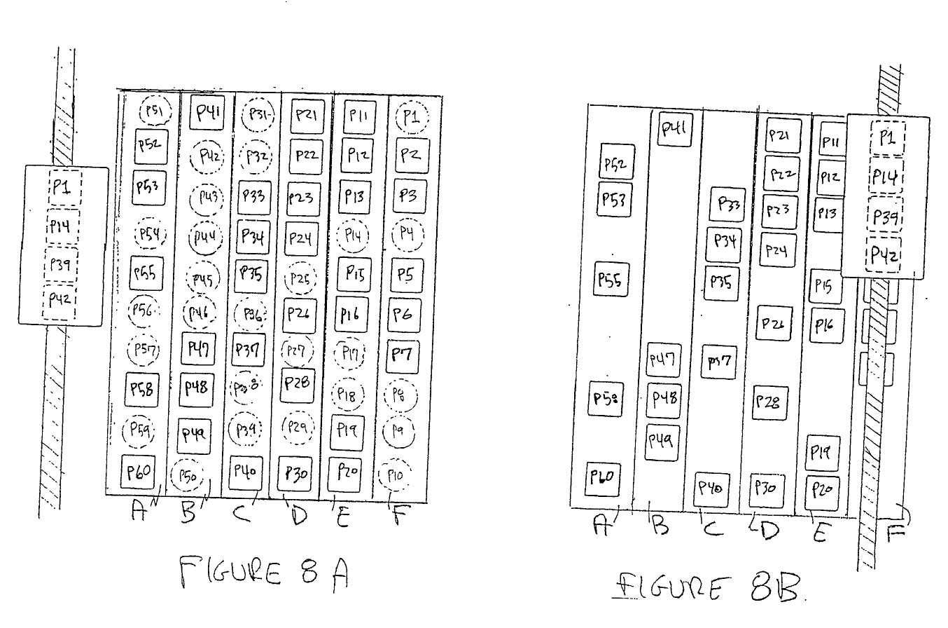

Preferably orders for contact lenses and customized graphics are received by a separate order processing system and communicated to the shop floor controller 512, preferably from a central customer order machine server (not shown). Customer orders can be received by phone, mail, internet, facsimile, or by any method. Some order taking procedures are disclosed in U.S. Pat. No. 4,958,280, incorporated herein by reference, others are known in the art. Preferably, only the orders to receive customized graphics are communicated to shop floor controller 512. Order information includes, e.g. an order number, date of order, the person ordering, products ordered, the customized graphics to be printed on the cartons, and shipping address. In the preferred system 500, the shop floor controller 512 sorts the information in the orders for the labels that are to be printed onto the web, and stores this information in a database. FIG. 6 shows a database 60 which can be used to store the sorted order information. FIG. 6 is only exemplary and more or fewer fields can be used to track the labels in the printing system 500 which would be apparent to a person of skill in the art. The database 60 includes fields for the order information such as the order number 61 (each order has an order number), and product SKU 62 identifying the type of product ordered, and the customized graphics 63, 64 which was specified by the doctor and/or patient for the product. Graphics field 63 specifies, e.g., background art. Graphics field 64 specifies, e.g., a message. More or fewer fields can be provided as desired. Other fields, e.g., the SKU field can indicate additional non-customized graphics to be printed onto the label. One or more of the fields in database 60 may be keyed to additional databases which may provide additional information when needed, e.g. the order number may be keyed to a database having the doctor's name and address, and/or the identifying numbers in the graphics field are keyed to databases which indicate what graphics will be printed by the printer 502.

Preferably labels from the same order are printed adjacent to one another, and labels having similar graphics (e.g. the same background picture) are printed close to one another on the web, and a label identification means is assigned to each label. The sorted label information is communicated to the control unit 501 for the printer 502. A spool 550 of a web of label material preferably 32 cm wide is fed into a digital printer 502. The label material preferably consists of a polyvinylchloride coated paper top layer with an adhesive coated back, and a removable peel layer as described in reference to FIG. 4. An example of a commercially available web is a white-pigmented PVC with matte imprintable top coat on paper having an adhesive layer, such as Datacal PLV-400-FW Opaque MT/C-354 V-29 S50K-8, available from Flexicon Co. In the preferred mode the web is blank and not pre-cut or scored; however, in alternative embodiments the web could be pre-cut, scored, and/or have non-customized graphics pre-printed on the web. For example, the labels could be printed individually instead of on a web, and/or the labels could also have the brand information pre-printed on them. At present, there are preferably at least 5,000 labels printed onto the web on each spool. After all the labels to be printed onto a first web have been printed onto the first web, the first spool 550 is removed from the printer 502 and replaced with a second spool 550 having a blank second web.

The digital printer 502 preferably has the ability to vary 100% of the text and graphics for each label. The preferred printer is available from Xeikon or Indigo. The control unit 501 for the printer 502 controls the printing of the labels and instructs the printer 502, which customized graphics, and contact lens information, if any, to print on the labels as instructed by the shop floor controller 512. Each label also preferably has some label identification means, printed onto the label or on the web next to the label so that the label can be tracked. Unique information associated with the label identification means 65 is stored in database 60 in the shop floor controller 512 preferably with the location of each label on the web (preferably in fields 67, 68, 66 for row column and spool number, respectively), the customized graphics 63, 64 specified by the doctor or patient, and the product SKU 62 to receive the label. After the web moves through the printer 502 it is accumulated in an accumulator 504 before passing through a quality check station 505 which preferably uses visual inspection equipment 520, such as a spectrophotometer or densitometer to check the color density and registration of the toners, pigments or dyes. Densitometers and spectrophotometers useful for this application are available from Gretag Macbeth, such as Spectro Eye Spectrophotometer D200-11 Process Densitometer, and D19C Densitometer, and available from X-Rite, Inc., such as SP99 Multi-Angle Spectrophotometer, and 408 Color Reflection Densitometer. Presently, the densitometer is hand-held; however, a fixed densitometer may be used in the method of this invention. Additionally, an operator can perform a subjective evaluation of the labels.

Presently, the visual inspection equipment 520 may continuously check the quality of the graphics and provide feedback to the control unit 501 which will cause the printer to automatically make adjustments, or will notify an operator if the printer cannot self-correct a printing problem. If the print quality is below a certain level, the labels in that area of the web will be rejected, which will be noted in the label control system 503 (computer comprising processing instructions and memory), and communicated to the shop floor controller 512 (computer comprising processing instructions and memory) which will schedule the rejected labels for reprinting. The rejection will be noted in field 69 of the database 60,and the shop floor controller 512 will instruct that the rejected label be reprinted. This can be accomplished by moving the fields 61, 62, 63, 64 for any rejected labels into a later record in the database with other incoming order information, while maintaining the rejected label information in the other fields for tracking purposes.

Preferably, an operator at the quality check station 505 will do a visual inspection of the labels on the web at set intervals, e.g. every 15 minutes. At that time an operator will scan the label identification means on the web with a handheld scanner 519 which will input at least one label identification means in the area of the web which is being inspected into a label control system 503. The handheld scanner 519 preferably is a bar code scanner. If there is a problem with the labels, the operator will communicate through the handheld scanner 519, via a keypad or the like, to the label control system 503 that the labels have failed inspection, and all the labels printed since the last operator inspection are to rejected. The rejected labels since the last inspection will be determined by the label control system 503, and communicated to the shop floor controller 512. The rejection of the labels will be noted in database 60 in field 69 and eventually those labels will be reprinted.

After the quality of the print is checked the web is rewound in a rewinder 506. The core of each spool 550 has an identification means, preferably a machine readable code, such as a bar code or the like, so that the shop floor controller 512 and label control system 503 can track each spool 550, and associate in the database 60 the identification means of the labels with the spool 550 on which the labels have been printed. (The label control system 503, preferably has a database similar to database 60). If individual labels on the spool do not pass inspection, or if the whole spool does not pass inspection, the control system 512 will instruct the printer to reprint the labels and update the database 60 and also communicates to the label control system 503 the new location (row, column and spool) of the reprinted labels. Preferably if any of the labels for a single order do not pass inspection, all the labels in an order will be reprinted on a new spool to keep all the labels for the same order together.

Next, the web on the spool will preferably be unwound on unwinder 507, and fed into a varnish station 508 in which the web, particularly the labels on the web, will receive a UV radiation cured varnish to improve their looks, and increase the labels' abrasion resistance. An example of a suitable varnish is INXCURE UV FLEXO P/I COATING which can be applied by, for example, a Belmark varnish applicator, which comprises anilox rollers. Preferably the web is inspected after the application of the varnish to be sure that the varnish was correctly applied and to check for any other flaws or errors. The inspection can be by an operator or by visual inspection equipment (not shown) similar to the apparatus and method described above. The inspector will preferably use a second handheld scanner 519 to input the identification means of the labels checked, and again individual labels or the entire web may be discarded if there is a problem with the varnish applicator and labels do not pass inspection. If the web is to be discarded the label control system 503 will note the identification means of the spool, and communicate this information to the shop floor controller 512, which will update the database 60, particularly field 69, and which will instruct the printer 502 to reprint all the labels on the spool. If only certain labels are to be discarded, the label control system 503 will note the label identification means of the labels that did not pass inspection, and will communicate this information to the shop floor controller 512 which will update the database 60 and which will instruct the printer 502 to reprint the labels that are to be discarded. Preferably all the labels in an order will be reprinted together on a single spool.

After inspection, the web is fed into a die cutter 509 which cuts the labels through the top layer of the web, and in a next step the top layer of the web around the labels is removed from the web, leaving the labels on the peel layer. In the preferred embodiment two separate apparatuses manufactured by Preco perform the just-described steps. In the preferred embodiment, multiple, e.g. three columns of labels are printed on the web. After cutting the labels, the web is cut widthwise into smaller reels 551, e.g. three reels, in a slitting machine 510. The reels are tracked by a machine-readable code on the core of each reel. Prior to slitting the web, the label control system 503 updates its database by assigning the labels in each column on the spool to one of three reels, which is noted in field 70, when the reels and spool are mounted upon the slitting machine. The labels are preferably printed on the web, so that labels for products in the same order are printed adjacent to one another in the same colurnn. As shown in FIG. 6, the three products for order number 10,175 are printed in column 1 of spool 2.

Presently, labels are only printed for products which are in inventory; therefore, any reel 551 can be selected by an operator and put on the label applicator 513. When the machine readable code for the selected reel is inputted into the label control system 503, preferably via a reader (not shown) located on the label applicator 513, the products onto which labels are to be adhered are pulled from inventory and sent to the customized graphics printing system 500. In an alternative embodiment, each reel 551 can be set aside until all the cartons that are to receive the customized labels on that reel have been picked from inventory. In either embodiment, the orders for which the labels are ready for placement on the products are communicated from the shop floor controller 512 to order picking and/or assembly equipment (not shown) which picks the cartons from inventory. Preferably, the cartons which are to receive the labels are transported to the label applicator 513 on a conveyor 514 (cutaway section shown), preferably the cartons are in the same sequence as the labels for the cartons on the reel 551. Alternatively, the cartons could be transported in assembled orders in a container or belt section (not shown) of conveyor belt 514. Each belt section can have a machine-readable code tied to the order which is within the belt section. The machine-readable code of the belt section and the related order information could be communicated to the shop floor system 512 from the equipment which assembled the orders.

In any embodiment, preferably the orders are conveyed to the system 500 in the same sequence that the customized labels for the orders are present on a reel, and/or preferably the product cartons within an order are conveyed to the system 500 in the same sequence that the labels for the orders are present on the reel. Preferably, the cartons are conveyed to the label applicator on a one carton-wide conveyor 514 in exactly the sequence of the usable labels on the reel.

The process and system of sorting, and in a preferred embodiment, sequencing, of products constituting an order (order building) as subject of the present invention, is now described in the context of the following preferred embodiment. It will be appreciated that any sequence can be assigned to arrange the products in the order builder of the present invention. In practice, a portion of an order can be so arranged, or one or more orders can be so arranged. In a preferred embodiment, the products are arranged to correspond to a label sequence.

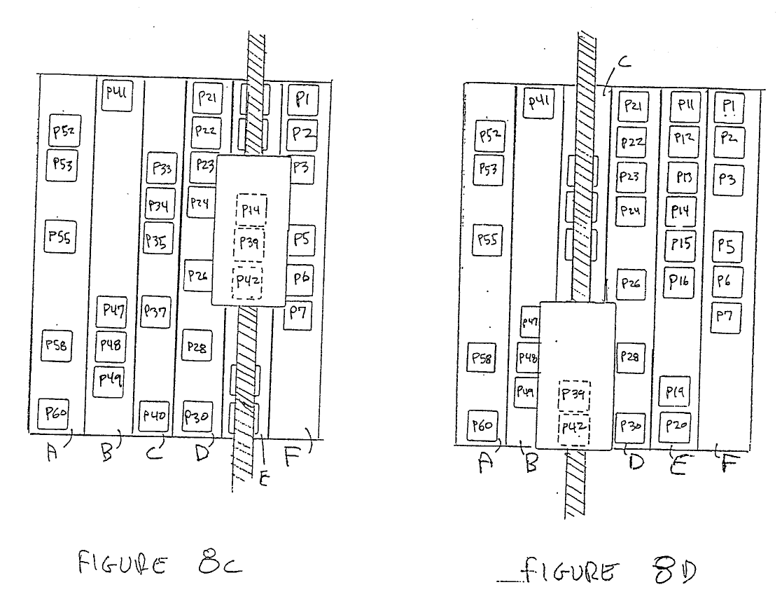

With reference to FIG. 7: order builder 109 receives product packages pulled from inventory in response to order information as elsewhere described herein. Product packages 110 so pulled proceed along in-feed conveyor 111 of order builder 109 to scanner 112. Product packages 110 are randomly sequenced; that is, the products are typically assembled in response to order information for a multiplicity of orders for the same or different products The sequence in which packages are removed from storage, or provided directly from a manufacturing line, to in-feed conveyor 111 can be a function of convenience or optimization for these product handling steps; it is not necessarily the sequence associated with a particular order or the sequence associated with going from one order to another. For example, where several orders call for a common product, in addition to different ones, the common product is often all pulled from storage at one time because this is optimal. These products will then find themselves all together on infeed conveyor 111 even though they are all not for the same order. It will be appreciated that although products assembled for sorting may be randomly sequenced as they are pulled from inventory or the like, it is preferred that one or a number of complete orders will be present within the group of products that are to be sorted within the order builder as contemplated by the invention, unless the order is for more than the number of products that the order builder can hold at one time. Hence, even though products may be pulled in accordance with order information in an optimized fashion, eventually even products inconveniently located in storage will be pulled to complete a given order. In a preferred embodiment, the order builder of the present invention can receive up to about 60 randomly sequenced products for sortation at a time. While the speed at which the order builder of the present invention can sort products into the orders they are associated with can vary, in a preferred mode up to about 45 products per minute can be sorted. Other variations on the circumstance described hereinabove where product is assembled in a random sequence in response to order information will be apparent to those in the art, and all are contemplated by the instant invention. A preferred practice for product handling and assemblage in this regard is that which is described in “APPARATUS AND METHOD FOR AUTOMATED WAREHOUSING AND FOR FILLING ORDERS FROM MULTILAYER INVENTORIES” (VTN-0453), U.S. Ser. No.________, filed________ , the contents of which are incorporated, in their entirety, by reference herein. For example, and without limitation to the present invention, customer orders are received by telephone, mail, internet, facsimile or any other method, and are organized into a database (not shown). The sequence as to how products are picked from inventory to fulfill the orders can prioritized according to the level of demand for a particular product, its location and the like. One or more robotic arms or similar device can be utilized to pick the products from inventory consistent with said prioritization, with subsequent transfer of picked product to the order builder of the present invention.

It will be further understood to those in the art that although the phrase “product packages” and the like as employed in the course of the following discussion, e.g. product packages 110, the present invention is not so limited; for example, while in a preferred mode the instant invention contemplates prescription products such as ophthalmic lenses which typically are housed in packages, which packages can have the product identification means (product identifier) thereon as has been described herein, the invention also contemplates circumstances where a particular product itself is not in a package, but rather has the product identification means directly thereon. Additionally, the term “product identifier” as used herein is for convenience of presentation and is intended to be synonymous with the phrase “product identification means” as has been elsewhere described in this specification.

Product packages 110 each have a product identifier thereon (not shown), preferably a barcode or the like. Information associated with this identifier is stored in one or more databases (not shown) as is the relevant order information as hereinbefore defined, e.g. the types of products, any customized label graphics, and quantities of product associated with each individual order. Scanner 112 may be of any type, such as an optical scanner coupled with optical character recognition software which may be stored in scanner 112 or in a separate database accessible thereby. Scanner 112 may also be an infrared or magnetic scanner for reading compatible identifiers on the product packages. In a preferred embodiment, scanner 112 is a barcode reader and the product identifier is a barcode. Scanner 112 inputs the identifier from the product package being read to at least one computer (not shown) having access to the databases aforesaid. After or concurrent with having its identifier read, the product package moves into position for push bar 113 to transfer it into singulator 114. As will be appreciated, scanner 112 and push bar 113 can comprise a single component even though depicted as separate components in FIG. 7. In FIG. 7, the package denominated as “6” is shown as being in such a position; the package denominated as “5” is shown as having already been pushed and nested into singulator 114. As depicted in FIG. 7, singulator 114 has four product package nests; however, a greater or lesser number of nests can be employed. In a preferred embodiment, singulator 114 is aligned with in-feed conveyor 111 and moves in the same direction as conveyor 111 at a speed coordinated to properly position an open nest, preferably the next open nest, with the action of push bar 113 so as to facilitate transfer of the product package from the conveyor (the preferred direction of travel for push bar 113 and singulator 114 respectively in this regard being shown by the dotted arrows in FIG. 7). The motions associated with in-feed conveyor 111, push bar 113 and singulator 114 may each individually be continuous or intermittent so long as consistent with the above constraints.

When singulator 114 is loaded (for example, when the packages denominated as “5”, “6”, “7” in FIG. 7 have all been nested), transfer device 115 operates to pick the singulated product packages from singulator 114 and convey them to order builder zone 116. As will be appreciated, the present invention can also be practiced under circumstances where singulator 114 is less than full when conveyance by transfer device 115 occurs. Transfer device 115 preferably has one or more grippers operative, by vacuum or the like, to pick product packages from singulator 114, and hold and deposit same at specific positions at order builder zone 116 in response to computer instructions (the computer not shown). In a preferred embodiment, transfer device 115 operates in cooperative relation with singulator 114 to effectuate pick up of product packages; for example, it is preferred that once loaded, singulator 114 automatically moves to position 117 (shown in FIG. 7 in dotted lines) whereat transfer device 115 will pick the product packages.

Transfer device 115 is preferably motorized, or otherwise powered, and configured to move up and down rail 118 and is moveable back and forth along rails 119 and 120 thus providing complete coverage to order builder zone 116. As shown in FIG. 7, order builder zone 116 is comprised of six lanes, denominated A, B, C, D, E, and F, six lanes being depicted for convenience, it being understood that a greater or lesser number of lanes can be employed in the practice of the invention. In one practice, each lane is dedicated to a particular order and will receive product packages associated with that particular order; but as will be appreciated, any given order if large enough can require more than one lane or can require multiple cycles of the system described herein to fulfill said order. Order builder zone 116 is further comprised of conveying means, e.g. each or some of lanes A-F can be constituted of a separate conveyor belt or the like; or more preferably, the entirety of order builder zone can be a single conveyor, the lanes being formed by dividers. In the embodiment shown, the conveyor comprising order builder zone 116 transfers the products packages once sequenced to accumulation zone 121. In addition to the two dimensional movement described above, transfer device 115 is additionally configured in a preferred practice to be able to stop over any point within order builder zone 116; more preferably over any spot within lanes A-F. These spots are preferably determined by said computer to correspond to the label sequence. Transfer device 115 is also preferably downwardly moveable, or extendible in whole or in part, in order to facilitate precise positioning of a product package in order builder zone 116; in a preferred practice, transfer device 115 is configured to permit downward extension of the grippers toward the plane of order builder zone 116 sufficient to accurately deposit a product package at a desired location in zone 116 without significant movement of the package on placement.

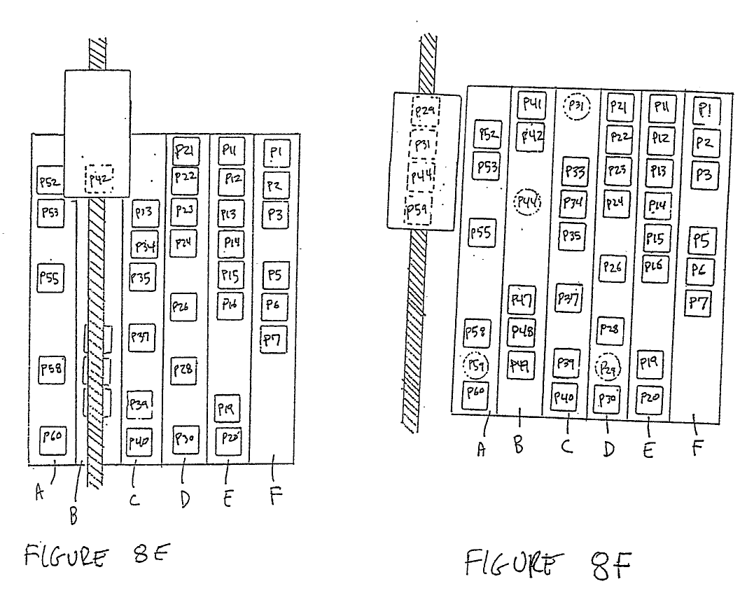

FIGS. 8A-8F are top plan views illustrating an embodiment of an automatic sorting and sequencing cycle contemplated by the invention using the preferred system of FIG. 7. FIG. 8A depicts the cycle at the point wherein transfer device 115 has picked up four product packages, denominated as “P1,”“P14,”“P39,” and “P42.” In the preferred practice shown in FIG. 8A, transfer device 115 has picked up these packages from singulator 114 at position 117. The product packages P1, P14, P39 and P42 are shown in dashed lines to denote the fact that in this embodiment they are on the bottom side of transfer device 115, preferably held in place by vacuum operated grippers. Packages P1, P14, P39 and P42 had been randomly placed on in-feed conveyor 111 either from a storage facility or direct form the manufacturing line response to an order or a multiplicity of orders requesting these products. The products housed by packages P1, P14, P39 and P42 may be the same or different, and may be individually be associated with the same or different orders.

Product packages P1, P14, P39 and P42 have had their barcodes (product identifiers) read by scanner 112 and inputted into the databases accessible by the computer or computers (not shown) which track these against the respective orders (order information) for same. In one embodiment contemplated by the invention, the packages are sorted by transferring products associated with a particular order to an order builder zone for that order. For example, as shown in FIG. 7, product packages associated with a particular order are transferred by device 115 to the lane or lanes or portion of a lane that has been identified for that particular order by the databases described herein. Hence in FIG. 7, products randomly sequenced on the conveyor will be picked up in this same sequence by device 115, but they will be deposited by 115 onto the proper area of the order builder zone, e.g. the lane dedicated to the order to which they are associated; this sorting of the randomly-sequenced products by transferring them to their respective order builder zone or zones is caused by the reading of the identifiers on the products by scanner 112 as they proceed past same with input and reference to the order information in the databases as to which order the particular product just read belongs to, and where in the order builder zone, e.g. which lane or lanes, is that order is being built. As discussed elsewhere herein, in another embodiment, labels for these products have been printed, preferably customized pursuant to instructions received as part of the order. These labels are preferably situated on a reel (e.g. element 551, FIG. 5); and the sequence by which they will be applied from the reel to their respective products has been inputted into said one or more databases (the label sequence) by reading the machine-readable code located on the reel, also as disclosed elsewhere herein.

In FIG. 8A, order builder zone 116 is shown divided into six lanes, A-F. In the embodiment depicted, each lane is capable of holding up to ten product packages, although those of skill in the art will recognize that the invention contemplates packages of different sizes and shapes and an order builder zone or zones of different configurations and/or dimensions to accommodate same, including without limitation, a greater or lesser number of lanes. In the practice illustrated in FIG. 8A, each position in each lane that can be occupied by a product package preferably has an address in the one or more databases, or is otherwise mapped or positionally identified by techniques known in the art, which addresses and the like are accessible to said computer or computers. As shown in FIG. 8A, these positions are, for purposes of illustration, identified by the numbers P1-P60, with squares (solid lines) representing products that have already been placed, and circles (dashed lines) representing open spots awaiting product.

Without limiting the present invention in any way, but merely to exemplify same, the following example is offered. It will be recognized by those in the art that various permutations and other modes of processing are apparent and within the scope of the invention. In this example, a multiplicity of orders for prescription products (e.g. ophthalmic lenses) will be presumed received. The orders are from eye care professionals, distributors and/or patients seeking refills. As elsewhere described herein, some or all of these orders come with instructions to personalize the labels that will be applied to the products. For purposes of this example only, three separate orders (denominated herein as Order No. 10175, Order No. 11139 and Order No. 12345) will be presupposed, the product packages constituting each order will receive a label customized for that order. The first order is for three products; the second order is for twenty seven products; and the third order is for thirty products.

As discussed herein, and for example as illustrated in FIG. 6, order numbers (in column 61) are assigned to each order, and the type of products needed to fulfill the order is associated with same by its product identifier (in column 62), e.g. its SKU. Thus in the present example, and with cross reference to FIG. 6, the first order is assigned Order No. 10175 and three products associated therewith are shown in column 62 by SKU product identifiers CL00525; CL01073; and CL01073. The label sequence for the first order (Order No. 10175) is shown in column 65 by label identifications 25433, 25434 and 25435. The second order is partly shown in FIG. 6 as Order No. 11139 along with associated product identifiers SKUs CL01073 and C100091 (the remaining products constituting the second order and those for the third order not shown). The products forming these orders are pulled from inventory e.g. in the manner described in “APPARATUS AND METHOD FOR AUTOMATED WAREHOUSING AND FOR FILLING ORDERS FROM MULTILAYER INVENTORIES” (VTN-0453), U.S. Ser. No._____, filed_____, incorporated herein in full, supra; or are sent directly from the manufacturing line.

In the present example as illustrated in FIG. 8, the products denominated P1, P2 and P3 are for the first order (Order No. 10175; with P1 being CL00525, P2 being CL01073 and P3 being CL01073); Products P4-P30 are for the second order; and products P31-P60 are for the third order. These products are randomly assembled, e.g. not pulled from inventory order-by-order, but rather pulled on considerations of convenience, inventory location, SKU number, etc., and fed in this random manner to the order builder system 109 of the present invention. As elsewhere described herein, the labels for the individual products associated with each order are prepared and placed on reel 551; the sequence in which they are to be applied from the reel (the label sequence) is known to the computer through the one or more databases. See e.g. database 60 as represented in FIG. 6, column element 65 which lists label identification numbers in the sequence they will be applied. As products P1-P60 move randomly past scanner 112, their product identifiers (e.g. SKU's) are read and matched up in the database with the order number they are associated with, and with the labels (by the label identification) that will be individually applied to them. This database, or one similar, also accessible to the computer, will have the addresses on order builder lanes A-F for the products, updated as placement occurs. For example, in the database depicted at FIG. 6, column 71 lists the positional sequence for each product in the row/column matrix at that point in time corresponding to the configuration of the order builder illustrated at FIG. 8A. As seen in FIG. 8A, in lane F, products P2 and P3 for Order No. 10175 are already positioned in the order builder, but not yet product P1. Similarly, for Order No. 11139, product P5 has been placed, but not product P4. This is reflected in the database of FIG. 6 where products P2 and P3 (having SKUs C101073) are listed under batch column 71 as 2 and 3 denoting their respective position on the order builder, with P5 (SKU CL00091) listed under batch as 5, consistent with its position. Batch numbers for P1 and P4 are blank, indicating they have yet to be placed; these are then updated upon deposition of P1 and P4 and so on. Column 72 of FIG. 6 shows the status, i.e. it indicates the last entity of a batch. Thus as shown, batch 3 (P3) is the last (end) entity of Order No. 10175. Other variations on such tracking and updating are recognizable to these of skill in the art and are within the scope of the present invention.

In FIG. 8A, lane F will be used to build the first order (Order No. 10175), which requires products P1-P3; lanes F, E and D will be used to build the second order (Order No. 11139), requiring products P4-P30; and lanes A, B and C will be used to build the third order, needing products P31-P60. In that part of the exemplified cycle shown in FIG. 8A, transfer device 115 has already picked up products P1, P14, P39 and P42 from singulator 114 at position 117. These particular products have already had their product identifiers (e.g. barcodes) read, and from the databases aforesaid it is known to which order (by order number) each of these products is associated. For example, it is known that P1 (SKU CL00525) belongs to Order No. 10175 being built in lane F. Products P1, P14, P39 and 42 are depicted in dashed lines to denote the fact that in this embodiment they are on the bottom side of transfer device 115, preferably held in place there by vacuum operated grippers. Also as shown in FIG. 8A, some of the various products needed to fill the orders have already been placed on order builder lanes A-F in accordance with the invention as now described. That is, they have been sorted according to which order they belong to, and placed in a sequence that corresponds to the label sequence. Thus in FIG. 8, lane F is shown having products P2 and P3 already deposited; these represent SKUs CL01073 and CL01073, both belonging to Order No. 10175. Furthermore they have been placed in a sequence that corresponds to the label sequence for this order and these products— namely, labels 25434 and 25435 which will later be applied.

The computer having access to these database(s) tracks which products (by product identifier) have been already placed against the respective orders (by order numbers) and where in the label sequence they are; it also recognizes from scanner 112 that product P1 now being processed by transfer device 115 belongs to Order No. 10175 (being built in lane F); that product P14 belongs to Order No. 11139 (being built in lanes F, E and D); and that products P39 and P42 belong to the third order Order No. 12345 (being built in lanes A, B and C). From the label sequence in said database(s), it is determined that product P1 belonging to Order No. 10175 is required in the spot designated in FIG. 8A as number “P1” (dashed circled) which corresponds to label identification 25433 (FIG. 6). As shown in FIG. 8B, transfer device 115 is movably configured to access each order builder zone position and travels along rails 118, and 119 and 120 (not shown) to spot “P1” whereat it places P1. In FIG. 8C, transfer device 115 has moved to place P19 in spot “19” for Order No. 11139, determined from the database as the location corresponding to the related label sequence for this order and product. Likewise, in FIGS. 8D and 8E, transfer device 115 has placed products P39 and P42 associated with Order No. 12345 being built at lanes C and B respectively in positions thereon that correspond to the label sequence. In FIG. 8F, the cycle is depicted as starting anew, with transfer device having picked up products P29, P31, P44 and P59. Consistently with the foregoing, these will be placed in positions on order builder zone 116 that correspond to the label sequence. Thus, P29 is associated with the second order, Order No. 11139 and will be placed in lane D at the spot denoted in FIG. 8 as “P29” (dashed circled); likewise P31, P44 and P59 are all associated with the third order, Order No. 12345, and will be deposited in lanes A, B and C at the designated locations which correspond to the related label sequence.

Once built in their respective lanes, the orders are preferably conveyed to accumulation zone 121. One or more such accumulation zones may be employed to enable an increase in the speed of order builder operations or to account for any difference in the speed of operation between products coming into, being processed by or exiting the order builder. In one embodiment, each of lanes A-F are comprised of separate conveyor belts that can operate in concert with or independently of one another; in a more preferred embodiment, one or more of lanes A-F, most preferably all of lanes A-F, are comprised of a single conveyor belt that transfers the all products in lanes A-F to accumulation zone 121 in a single motion. For considerations of efficiency, it is preferred that this occurs after the order builder zone 116 is full, e.g. each of lanes A-F has 10 products thereon. Those in the art will appreciate that other methods of conveying products from order builder zone 116 to accumulation zone 121 can be employed. Alternatively, the present invention contemplates an order builder process and method which does not employ an accumulation zone 121. In this practice, the products can exit order builder zone 116 to label applicator 513 either directly by out-feed conveyor 514 or otherwise.

In a preferred practice where accumulation zone 121 is utilized, a second transfer device 122 is employed to pick the sorted products up and transfer them to out-feed conveyor 513 which directs them to label applicator 513. One or more second transfer devices 122 can be used in this regard. Second transfer device 122 is preferably motorized, or otherwise powered, and is configured to move along rail 123. In the embodiment shown in FIG. 7, second transfer device 122 is configured to pick up all products in a given lane at one time, e.g. all products denoted as 125 in lane E′, and transfer them to out-feed conveyor 514 wherefrom they proceed to label applicator 513. Transfer device 122 preferably has vacuum operated grippers or the like and is downwardly mobile or extendible to facilitate placement. In operation, second transfer device 122 can pick any lane of product, e.g. A′-F′ as depicted, and deposit the products of that accumulation lane onto out-feed conveyor in a manner that matches the label sequence.

The cartons are conveyed to the label applicator 513. A product handler e.g. a robotic arm (not shown) may be used to pick product off the conveyor and place the product into the label applicator 513. Useful labelling equipment is commercially available. As each product receives a label it is preferably pushed or placed on a second conveyor 517 which transports the products to a final verification, packaging and shipping area (not shown). The products are preferably maintained in the same sequence, preferably with spaces between individual orders on conveyor 517.

Preferably, the label applicator 513 will only apply a label on a carton after verifying that the proper carton is present by reading the identification means on the conveyor section (if applicable) via a reader (not shown), and/or by reading the identification means on the carton via a reader (not shown), and/or by reading the label identification means via a reader (not shown). The label applicator 513 will automatically skip the labels on the reel, which are to be discarded. (The shop floor control system 512 provides the tracking information on the labels as recorded in database 60 to the label applicator 513.) The label applicator 513 also preferably comprises an inspection mechanism (not shown) which makes sure each label is in the proper position and without wrinkles prior to allowing a carton to be conveyed to shipping. If the inspection mechanism, such as a vision system, or an operator does not pass a labeled product, preferably the cartons which do not pass inspection are discarded and the method will be repeated from the beginning for those cartons, and the rest of the cartons in a single order will be set aside. If there is an error in the applicator 513 that requires an operator's attention, the operator may use the handheld scanner 519 to communicate to the label control system 503 that certain labels should be discarded, which will be noted by database 60 and the shop floor controller 512. This step can be done at any point in the method of printing or otherwise producing the labeled product.

The label applicator 513 preferably continues the verifying, labeling, and inspection steps until all the labels on the reel have been put on cartons. When the reel has no more labels to apply, a signal to an operator will indicate that the reel 551 should be changed, and either the operator can place whichever reel he/she wants onto the label applicator 513, or the shop floor controller 512 will communicate to the operator the next reel 551 to put on the label applicator 513, and the process of applying the labels will continue.

In a preferred practice, the system of the invention is operated to minimize and even eliminate errors that could otherwise potentially occur in the automated sorting and/or label application contemplated herein. In one embodiment of this practice, products are picked from inventory as described for example in “APPARATUS AND METHOD FOR AUTOMATED WAREHOUSING AND FOR FILLING ORDERS FROM MULTILAYER INVENTORIES” (VTN-0453), U.S. Ser. No.____, filed____, incorporated herein in full supra, and transported to or placed directly on in-feed conveyor 111 to order builder 109. In this practice, the sequence of the products as they are picked and placed on said conveyor (the inventory sequence), although random in relation to the various order information being processed as described aforesaid, is stored in the one or more databases. Hence the (random) sequence by which these products arrive at scanner 112 can be cross checked against the sequence by which they were picked and conveyed to same in the first instance. That is, as the product identifiers for these products are read by scanner 112, this information is inputted into said databases wherein the sequence of their arrival at scanner 112 is compared against the sequence in which they were originally picked from inventory and placed on the conveyor 111 to order builder 109. If the sequences do not match because e.g. one or more of the products may have fallen off the conveyor or have otherwise been shuffled out of their picked inventory sequence or have had their product identifiers damaged to the point where they are unreadable or a jam exists somewhere in the system interrupting product flow, the system can be operated to indicate this by e.g. alarm, signal or other means of indication, and preferably to stop the system to allow attendant correction. While the system can be operated to stop even if one product is out of sequence, certain override protocols are also contemplated. For example, in a preferred practice, if one of the four products nested in singulator 114 does not match up with the inventory sequence, because e.g. its product identifier can not be read, but the other three products do match up, then the system can be operated to assume that the one unmatched is the correct product; if however, two or more of the four do not match up, then it is preferred the system indicate this as an error with attendant stoppage to allow correction. Preferably, the system assigns to the unmatched product the product identifier for the product that was expected at that point in the inventory sequence. This protocol can be similarly employed at the label applicator. For example, in a preferred embodiment, up to ten products can be conveyed from accumulation zone 121 of order builder 109 by second transfer device 122 which transfers them to out feed conveyor 514 leading to the label applicator 513. As indicated above, the product identifiers on these products can be read via a reader (not shown) prior to label application. In a preferred practice, the sequence by which these products advance to the label application reader is compared against the inventory sequence. Non-matches are identified as aforesaid with appropriate indication of this condition and shutdown as desired. In a preferred practice, certain override protocols can be maintained. For example, if the product identifier on one of the ten products transferred by device 122 to conveyor 514 is unreadable by the label applicator reader (not shown), but the other nine are readable and match the inventory sequence, the system can be operated to assume that the entire label sequence for all ten products match the inventory sequence. Preferably, the system assigns to the unmatched product the product identifier for whatever product was expected at that point in the inventory sequence. If, however, two or more are unreadable, then the system preferably indicates this as e.g. an abnormal condition, preferably with stoppage to allow correction. In a preferred practice, correction is by operator intervention of the data record sequence, thus precluding the operator from having to handle the actual product and preventing any mistakes therewith. In another embodiment, correction occurs by operation intervention with the actual product sequence, e.g. replacement of the unmatched product consistent with the inventory sequence or the unjamming of equipment and the like, which condition caused the error indication in the first instance.

Before and/or after the application of the customized graphics, the packaging may have no human-readable identification of the prescription of the product and may only comprise a machine-readable identification means which is used to track the product through manufacturing and shipping. The customized graphics preferably will identify who the product is for, and may not indicate any prescription information. This is particularly beneficial to prevent the product from being provided to a person who does not have a proper prescription for the product.

While the present invention has been particularly shown and described with respect to preferred embodiments, it will be understood by those skilled in the art that changes in form and details may be made without departing from the spirit and scope of the invention as claimed hereunder.

What is claimed is:

1. A process for automatically sorting a random assemblage of products into individual orders which comprises:
a) providing at least one computer having access to one or more databases in which is stored i) order information for a multiplicity of orders for the same or different products, and ii) product identifier information;
b) providing a random assemblage of products in response to said order information, each of said products having a product identifier thereon;
c) scanning the product identifiers on the products of said random assemblage to cause sorting by transferring products associated with a particular order to an order builder zone for that order.

2. The process of claim 1 wherein said one or more databases also has stored therein iii) label information, said label information including a label sequence by which labels will be applied to products associated with a particular order; and wherein in step (c) said transferring further comprises placing said products in said order builder zone in a sequence that corresponds to the label sequence for said particular order.

3. The process of claim 1 wherein said order builder zone is comprised of a plurality of lanes, one or more of said lanes being dedicated to said particular order.

4. The process of claim 1 wherein said order builder zone is comprised of a plurality of lanes, one or more of said lanes being dedicated to an assigned sequence i) for a portion of said order or ii) for one or more orders.

5. The process of claim 2 further comprising step (d): feeding the products associated with said particular order from the order builder zone to a label application zone in a sequence that matches the label sequence.

6. The process of claim 5 further comprising matching the label to the product before said label is applied at the label application zone.

7. The process of claim 1 further comprising step (d): conveying the products associated with said particular order after placement in the order builder zone to an accumulation zone.

8. The process of claim 2 further comprising step (d): conveying the products associated with said particular order after placement in the order builder zone to an accumulation zone; and step (e): feeding the products associated with said particular order from the accumulation zone to a label application zone in a sequence that matches the label sequence.

9. The process of claim 1 wherein, in step (b), the random assemblage of products is provided on a conveyor belt.

10. The process of claim 1 wherein said product identifier is a barcode and said scanning is by one or more barcode readers.

11. The process of claim 1 wherein said sorting is provided by a transfer device having grippers thereon.

12. The process of claim 1 further comprising singulating products from the random assemblage of products prior to said sorting step.

13. The process of claim 1 wherein said one or more databases also has stored therein inventory sequence, said inventory sequence being the sequence by which said random assemblage of products were picked from inventory; said process further comprising comparing the sequence of the product identifiers on said random assemblage of products, after said scanning of step (c), to said inventory sequence to match same.

14. The process of claim 13 further comprising providing an indication when the sequence of the product identifiers on said random assemblage of products does not match the inventory sequence.

15. A process for automatically sorting and sequencing a random assemblage of products which comprises:
a) receiving a multiplicity of orders for the same or different products and storing same in one or more databases in which is also stored label information, including a label sequence by which labels will be applied to the individual products associated with each order, and in which is also stored product identifier information;
b) providing at least one computer having access to said one or more databases;
c) providing products in fulfillment of said multiplicity of orders to a scanner in a random sequence, each of said products having thereon a product identifier;
d) scanning the product identifier on each product and determining from said one or more databases which of the multiplicity of orders each product belongs to and where each product belongs in the label sequence;
e) grouping together the individual products associated with each order and sequencing them to match the label sequence.

16. The process of claim 15 further comprising, after step (e), feeding the individual products that have been sequenced a label applicator whereat labels are applied to said individual products according to said label sequence.

17. The process of claim 15 wherein said labels have thereon graphics customized for at least some of said orders.

18. The process of claim 17 wherein said products comprise prescription products.

19. The process of claim 18 wherein said prescription products comprise ophthalmic lenses, said ophthalmic lenses housed in packaging, said packaging having thereon said product identifier.

20. The process of claim 19 wherein said packaging is a carton and said product identifier is a barcode.

21. The process of claim 15 further comprising assigning, in said one or more databases, an order number to each order constituting the multiplicity of orders, and assigning to each said order number the product identifier for each individual product associated with said order.

22. The process of claim 17 further comprising, in said one or more databases, grouping each said order number together with its product identifiers, the sequence of which constitutes the label sequence.

23. A system for automatically sorting a random assemblage of products into individual orders, each of said products having a product identifier thereon, which comprises:
(a) one or more databases in which is stored i) order information for a multiplicity of orders for the same or different products, and ii) product identifier information;
(b) at least one computer having access to said one or more databases;
(c) scanning means to read the product identifiers on said random assemblage of products and input same into said one or more databases;
(d) sorting means controlled by said computer to transfer products associated with a particular order to an order builder zone for that order.

24. The system of claim 23 wherein in said one or more databases is also stored iii) label information, said label information including a label sequence by which labels will be applied to products associated with a particular order; and wherein said sorting means (d) further places said products in a sequence corresponding to said label sequence.

25. The system of claim 24 further comprising a first transfer means to transport said random assemblage of products to said scanning means.

26. The system of claim 25 further comprising means to convey said sequenced products to an accumulation zone.

27. The system of claim 26 further comprising a second transfer means to transport said sequenced products from said accumulation zone to a third transfer means feeding a label application zone.

28. The system of claim 27 wherein said sorting means is a first transfer device having grippers thereon; said first transfer means is a conveyor belt; said second transfer means is a second transfer device having grippers thereon; and said third transfer means is a conveyor belt.
